(19) United States
(12) Patent Application Publication
(10) Pub. No.: US 2006/0040610 A1
(43) Pub. Date: Feb. 23, 2006

(54) Broadcast messages

(76) Inventor: Mauri Kangas, Paimio (FI)

Correspondence Address: HARRINGTON & SMITH, LLP, 4 RESEARCH DRIVE, SHELTON, CT, 06484-6212, US

(21) Appl. No.: 10/535,062

(22) PCT Filed: Nov. 28, 2003
(86) PCT No.: PCT/IB03/05639

§ 371 Date: May 12, 2005

(30) Foreign Application Priority Data
Nov. 29, 2002 (GB) 0227952.9

(51) Int. Cl. H04H 7/00

(52) U.S. Cl. 455/3.06

(57) ABSTRACT

MMS messages are sent to a set top box for display on a television receiver (7). The MMS messages can be routed from a message centre (MMSC1) through a digital broadcasting network (4) to the STB. The messages can be directed to one of a number of individual message addresses associated with the STB. Also MMS messages can be multicast to individual addresses from a group service provider (9).

### FIELD OF THE INVENTION

This invention relates to methods of configuring a digital broadcast receiver, to a method of operating a digital broadcast network. The invention also relates to A digital broadcast receiver configured to receive MMS messages, and to a network configured to perform a method. The invention has particular application to a multimedia messaging service (MMS) but is not limited to such.

### BACKGROUND OF THE INVENTION

Hitherto, a short messaging service (SMS) has been used in mobile telecommunication networks to send text messages between mobile devices such as cellular mobile telecommunications handsets. More recently, a multimedia messaging service (MMS) has been developed to allow multimedia messages to be conveyed, including pictures, video clips and audio.

Also, email is a well known messaging service for computer networks, particularly wide area networks such as the Internet. Email can be sent from one personal computer to another in the manner well known in the art. MMS has the capability to transmit messages not only to a mobile handset but also to personal computers through the Internet. MMS messages are handled by a multimedia message service centre (MMSC) which is connected to the mobile network and also provides a portal to the Internet so that messages can be routed either to a mobile telephone handset or to a personal computer through the Internet.

Digital video broadcasting (DVB) may be used to broadcast television programs to domestic television receivers. In contrast with conventional analogue TV transmissions, DVB provides not only a downlink to the television receiver but also an uplink to allow interactive services to be provided. A set top box (STB) may be used to receive DVB transmissions and convert them into a format suitable for a conventional analogue television receiver. The STB may include an input section that includes a parser to parse input digital broadcast signals, which may be received through a cable, satellite or a terrestrial transmission system. A hard disc may be provided in the STB to record broadcast transmissions and an output modulator may be included to convert the digital data either from the store or in real time, into a UHF modulated analogue form suitable for reception by a conventional television receiver through its antenna socket.

It has been proposed to use the set top box as an email client connected to a conventional telephone land network and to display emails using the television to receiver. For further details reference is directed to “The Essential Guide to Digital Set, Top Boxes and Interactive TV” by G. O'Driscoll, Prentice Hall, ISBN 0-13-017360-6, pp170-180.

The present invention is directed to a system which allows messages such as MMS messages to be sent to an digital broadcast receiver such as a STB, through a DVB network for display using a conventional television receiver.

### SUMMARY OF THE INVENTION

According to a first aspect of the invention there is provided a method of configuring a digital broadcast receiver to receive individually addressed messages through a digital broadcast network, the messages being derived from a different network, comprising sending to the digital broadcast receiver through the network, message detection data that allows the digital broadcast receiver to identify messages broadcast through the network with at least one individual address corresponding to the digital broadcast receiver, and storing the message detection data for use in the digital broadcast receiver to detect messages addressed thereto.

The digital broadcast receiver may comprise a set top box (STB) and the messages may comprise MMS messages.

According to a second aspect of the invention, there is provided a digital broadcast receiver configured by the above-recited method to receive MMS messages.

According to a third aspect of the invention, there is provided a method of operating a digital broadcast network to configure a digital broadcast receiver to receive individually addressed messages through the network, the messages being derived from a network different from the broadcast network, comprising receiving specific data that individually characterises a particular digital broadcast receiver, providing message detection data as a function of said specific data that allows the digital broadcast receiver to identify messages broadcast through the network with at least one individual address corresponding to the digital broadcast receiver for storage therein to detect messages addressed individually thereto, and sending the message detection data to the digital broadcast receiver through the network.

A fourth aspect of the invention provides a network adapted to perform this method.

A fifth aspect of the invention provides a method of configuring a digital broadcast receiver to receive individually addressed messages through a digital broadcast network, the messages emanating from a network different from the digital broadcast network, comprising receiving at the digital broadcast receiver from the digital broadcast network, message detection data that allows the digital broadcast receiver to identify said messages broadcast through the network with at least one individual address corresponding to the digital broadcast receiver, and storing the message detection data for use in the digital broadcast receiver to detect messages addressed thereto.

In order that the invention may be more fully understood, an embodiment thereof will be described by way of example with reference to the accompanying drawings.

### BRIEF DESCRIPTION OF THE DRAWINGS

In the drawings:

FIG. 1 is a schematic illustration of a network for transmitting MMS messages in accordance with the invention;

FIG. 2 is a schematic block diagram of a set top box;

FIG. 3 is a schematic illustration of initialisation and downloading of message addresses and encryption keys to the set top box;

FIG. 4 is a schematic illustration of the downloaded data;

FIG. 5 illustrates the detection and storage process performed at the set top box;

FIG. 6 is a schematic illustration of the downloading of an encrypted MMS to the set top box; and

FIGS. 7A, B & C schematically illustrate different signal transmission formats for the MMS messages.

### DETAILED DESCRIPTION OF THE PREFERRED EMBODIMENTS

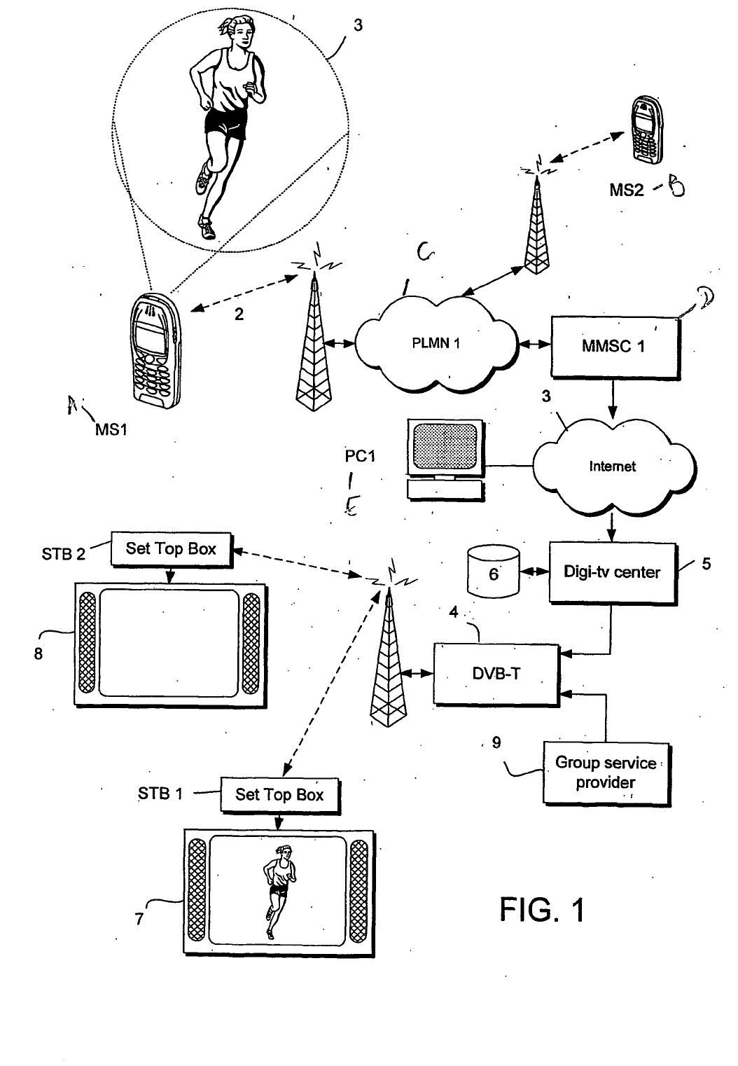

Referring to FIG. 1, a mobile cellular telephone handset MS1 is in radio communication with a public land mobile network PLMN1 through a cellular radio link 2. The handset MS1 includes the digital camera which can take a photograph of scene 3—a girl running. The handset MS1 includes digital processing circuitry which converts the image from the camera into a MMS in a manner well known per se. For example, the Nokia 7650 telephone handset can perform this function. The MMS may be transmitted under the control of MMSC1 either through PLMN 1 to another handset MS2. Alternatively, the user of handset MS1 may associate a TCP/IP address with the MMS, in which can MMSC1 routes the MMS image data as an email attachment directed to the IP address through the Internet 3. In this example, the MMS may be routed to PC1 connected to the Internet 3.

In accordance with the invention, the MMS may also be routed selectively to a set top box STB1 through a terrestrial digital broadcasting system (DVB-T) 4. To this end, the MMS is routed to a digit-tv centre 5 that provides services through the DVB-T system 4. The digi-tv centre 5 acts as a server for MMS messages and has a store 6 to receive messages from Internet 3 so that they can subsequently be conveyed through the DVB-T network 4 to individual set top boxes.

The set top box STB1 is connected to a conventional, analogue TV receiver 7. It will be understood that the DVB-T network 4 broadcasts to many television receivers illustrated schematically by a further television receiver 8 with an associated set top box STB2. The set top boxes STB1, 2 may also receive group services from the group service provider 9 through the DVB-T network 4.

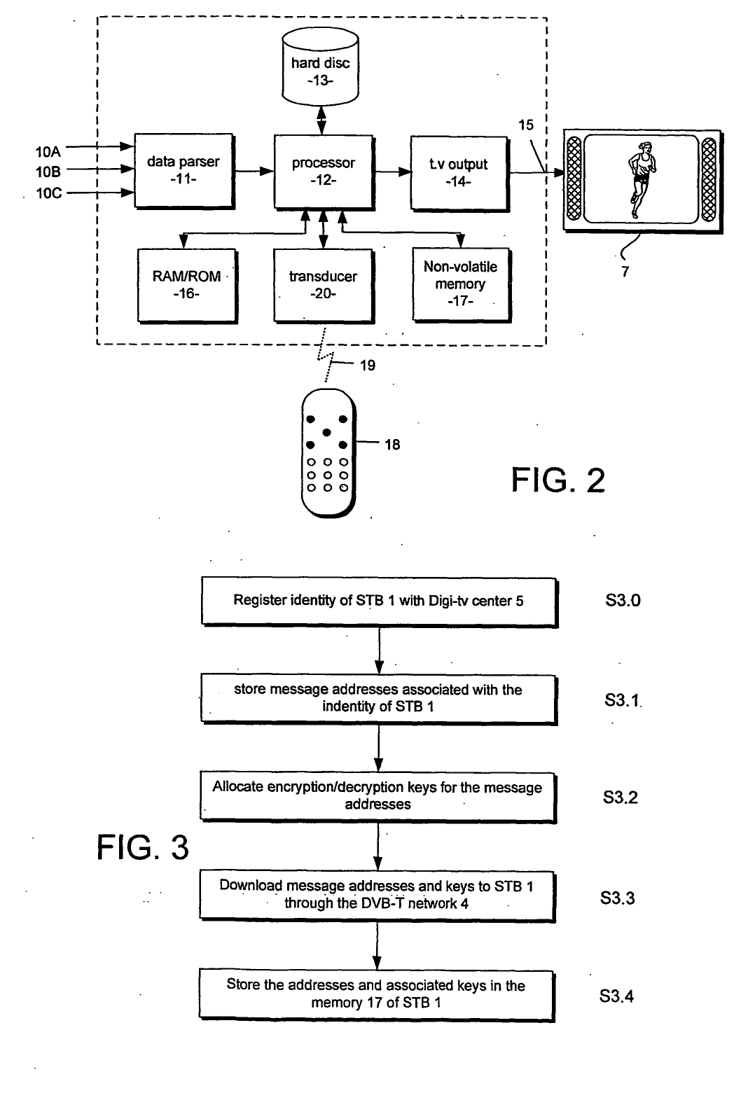

The set top box STB1 is shown in more detail in FIG. 2. Digital data from cable, satellite and terrestrial DVB networks are received on inputs 10A, B and C, and are fed to a data parser 11 that streams the received data to a processor 12 that either feeds the data to a hard disc 13 for storage or in real time to a TV output circuitry 14. The output circuitry 14 includes a D/A converter and a UHF modulator to provide signals on line 15 that are supplied to the conventional antenna socket of the analogue TV receiver 7.

The processor 12 has associated RAM/ROM 16 and also a non-volatile memory 17 which includes a substantially unique identification code for the set top box. The memory 17 may also include a unique key K_{STB1}. The non-volatile memory 17 may comprise a smart card. Thus, each STB has its own individual identity. A remote controller 18 controls operation of the processor 12 via a wireless link 19 e.g. infrared, through a transducer 20.

Thus, as well known in the art, the STB can be used to receive, record and feed TV broadcasts to the analogue television receiver 7 and the remote controller 18 is used to control channel selection both for real time display and for recording on the hard disc 13. Additionally, the set top box STB1 may also run an email client such as a web browser, to receive emails downloaded through the DVB-T network., to be displayed on the television receiver 7

In accordance with the invention, MMS messages may be downloaded to STB1 through the DVB-T network 4 and stored on hard disc 13 for display on the television receiver 7, the messages being manipulated by means of the remote controller 18.

The configuration of the STB for use with MMS messages will now be described. In an initial registration step, at least one mail address is associated with the identification number of the set top box STB1. This may be carried out at the time the set top box is purchased. The purchaser may be given an opportunity to provide a limited number of mail addresses at a domain associated with the digi-tv centre 5. For example, the following personal messaging addresses for members of the family Virtanen at a domain turkutv, a digital TV provider for the town of Turku in Finland, can be associated with the individual identification code for set top box STB1 as set out in Table 1.

TABLE 1

| STB 1 Identification | | | Encryption/decryption |
|---|---|---|---|
| code | STB unique key | Message addresses | key pair |
| wbdcxz485407437347 | K_{STB1} | maija.virtanen@turkutv.fi | Ka1:Ka2 |
| | | matti.virtanen@turkutv.fi | Kb1:Kb2 |
| | | marika.virtanen@turkutv.fi | Kc1:Kc2 |
| | | mikko.virtanen@turkutv.fi | Kd1:Kd2 |
| | | family.virtanen@turkutv.fi | Ke1:Ke2 |

These addresses are registered at the digi-tv centre 5 and stored on store 6 in association with the identification code and unique key K_{STB1} for STB 1. The registration process may be carried out by email e.g. from PC1 shown in FIG. 1 through the Internet or may be carried out at the time of purchase of the set top box by the retailer over a secure sockets link. The registration and address selection are illustrated as steps 3.0 and 3.1 in FIG. 3.

Then, at step S3.2, the digi-tv centre 5 allocates encryption/decryption keys for the stored message addresses individually. Examples of the key pairs are shown schematically in Table 1. The keys are used to encrypt and decrypt MMS communication through the DVB-T network 4 between the digi-tv centre 5 and the set top box STB1.

At step S3.3, the message addresses allocated to set top box STB1 and their associated encryption/decryption keys are downloaded through the DVB-T network 4 to the set top box STB1, and the downloaded data is encrypted using the STB unique key K_{STB1} associated with the set top box STB 1. Public/private key cryptography or symmetrical keys may be employed.

At step S3.4, the downloaded addresses and associated keys are stored in the memory 17 of STB1 for future use. The data decrypted using the STB unique key K_{STB1} and then stored or can be stored encrypted for subsequent decrytion using the STB unique key depending on the security requirements of the system and the implementation of the cryptosystem.

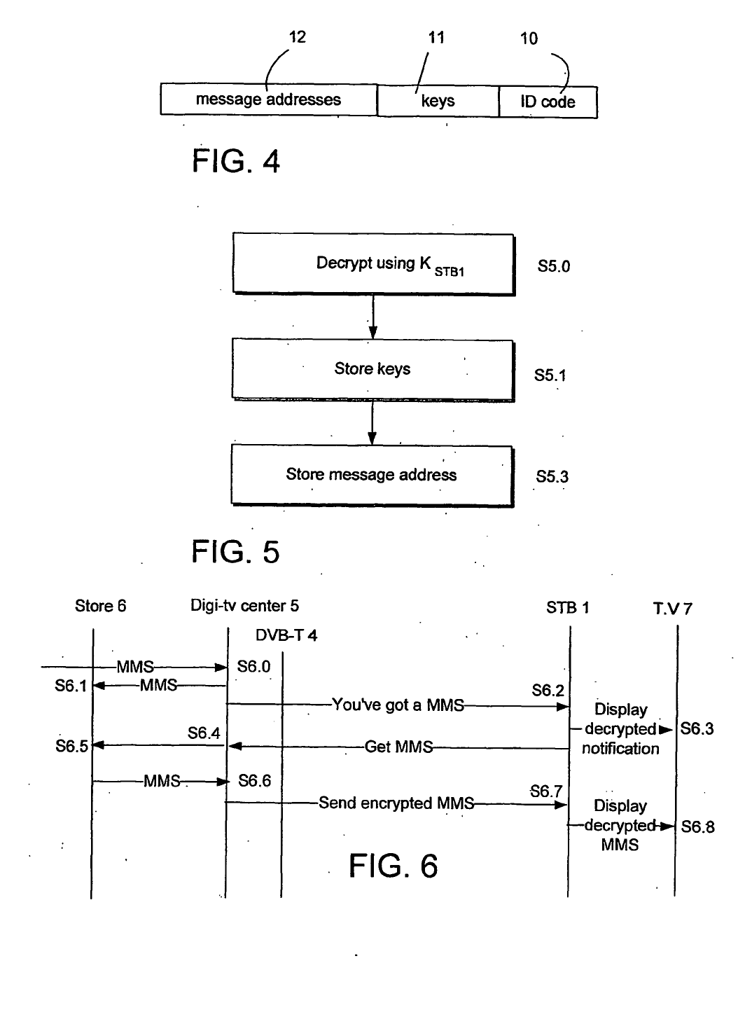

Referring to FIG. 4, the format of the encrypted data downloaded from the digi-tv centre 5 to the STB 1 comprises the identification code 10 of STB 1, the encryption/decryption keys 11 for the message contents and the message addresses themselves. Thus, the data of Table 1 is downloaded.

The process of reception and storage of the downloaded data is shown in FIG. 5. At step S5.0, STB 1 decrypts data received through the DVB-T network 4 using the unique key K_{STB1} from the non-volatile memory 17 of STB 1. When data is successfully decrypted, the decrypted data is intended for STB 1 and so the downloaded message addresses and their corresponding keys are stored in memory at steps S5.1 and S5.2. The header 10 in the decrypted data can be checked against the identification code stored in the memory 17 to validate the addresses and the keys. Alternatively, the identification code can be used as a header for the downloaded data so that the STB can detect its unique identification code in the data broadcast through the digital network 4, by comparing the received identification code with that stored in the memory 17. On detection of its unique code in the broadcast, the STB stores the keys 11 and the message addresses in the memory 17.

Thus, by this process, multiple addresses are associated with the identity of the set top box STB1 together with respective encryption/decryption keys. The STB1 is now ready to receive MMS messages.

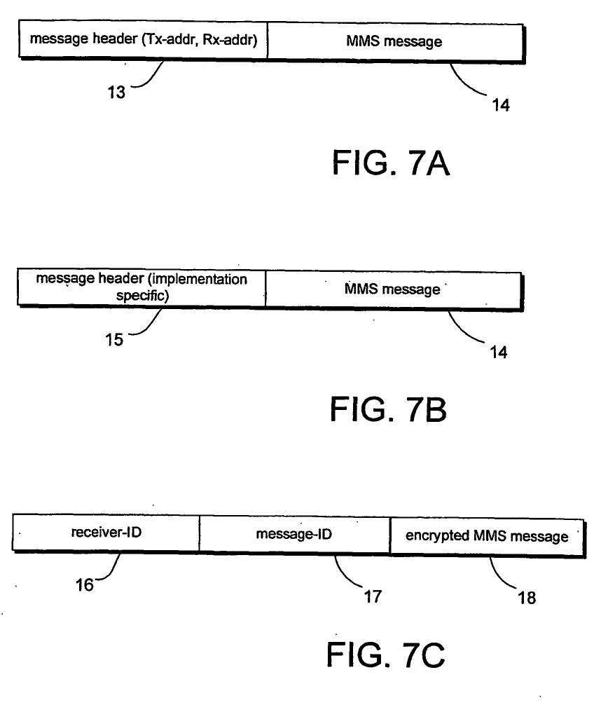

In the following example, the user of handset MS1 takes a photograph of the scene 3 and manipulates the keys of the handset so as to send the photograph as a MMS to one member of the family Virtanen, for example to the MMS address of Matti Virtanen. The MMS is transmitted over radio link 2 to the PLMN1 and thence to MMSC1, which decodes the address associated with the message and decides to forward it through the Internet to the digi-tv centre 5. This is shown at step S6.0 in FIG. 6. The received MMS is stored in store 6 at step S6.1, in association with the message identification code. Suitable formats for the MMS transmitted from MMSC1 to the digi-tv centre 5 are shown in FIGS. 7A and 7B. The MMS may be transmitted as an attachment to an email, in which case the format is generally as shown in FIG. 7A, with a header 13 that includes the IP address of the transmitter (MMSC1) and the receiver (digi-tv centre 5), together with the MMS message data 14 itself. Alternatively, an individual messaging protocol may be set up by the operators of the digi-tv centre 5 and MMSC1 that involves an application-specific client-server approach, in which case, the message may be configured as shown in FIG. 7B with an implementation-specific message header 15 for the MMS message 14.

The digi-tv centre 5 then retrieves the encryption key Kb1 associated with the message address matti.virtanen@turkutv.fi (see Table 1) and sends an encrypted message to the set top box STB1 through the DVB-T network 4 as shown at step S6.2. The notification message is then decrypted at the step top box STB1 using the stored decryption key Kb2 and the message notification is displayed on the screen of television receiver 7 at step S6.3 e.g. “Matti—you have a new MMS”.

The message recipient may then decide to request that the MMS be downloaded from the digi-tv centre 5 and a download request is uploaded through the uplink of the DVB-T network 4 to the digi-tv centre 5 at step 56.4. The download request may be encrypted using the encryption key Kb1 stored in the non-volatile memory 17 at STB1. If so, the request is decrypted at the digi-tv centre 5 using the corresponding decryption key Kb2. The request may be generated at STB 1 using an instance of the browser and a password authorisation may need to be entered. A retrieval command is then sent to the store 6 at step S 6.5. The MMS is then retrieved from the store 6 at step S6.6 and passed to the digi-tv centre 5. The MMS is then encrypted using the encryption key Kb2 and sent as an encrypted message at step S6.7 to STB1, where it is decrypted using stored decryption key Kb2. The resulting decrypted message is displayed in a browser window on the television receiver 7 at step S6.8.

A suitable format for the message downloaded at step S6.7 is shown in FIG. 7C and comprises a header which includes a receiver identification block 16 and a message identification block 17, together with the encrypted MMS message 18. The receiver identification block may include the identification code for STB 1 and/or the message address, namely matti.virtanen@turkutv.fi.

It will be understood that in accordance with the invention, the message could have been directed to any one of the five message addresses associated with identification number of the set top box STB1 in dependence on the address that was selected by the user of the handset MS1.

The transmission mechanism through the DVB-T 4 may make use of a data carousel in accordance with ETSI EN301192V1.2.1 (Section 8—Data Carousels) or the Multiprotocol Encapsulation method known in the DVB transmission art.

In the foregoing example, the downloading of the MMS makes use of the uplink in the DVB-T network 4 to request retrieval of the MMS message. However, the MMS message can be downloaded from DVB broadcasts without using the uplink. In this case the MMS messages are broadcast in DSM-CC carousel or with some other circulatory method and a 24-hour narrow bandwidth channel 1o may be transmitted under the control of the digi-tv centre 5, to circulate individually encrypted MMS messages continuously for decryption and reception by individual STBs. In this case, the STB 1 would not upload the MMS message download request to digi-tv centre 5. The MMS messaging structure would contain a table or several tables containing the scheduling information for the DVB data carousel. By looking into these tables each STB could decide when in the message broadcast schedule it could capture a MMS message directed to its message addresses.

In accordance with the invention, group message addresses for MMS messages may also be provided to enable the user of the set top box STB1 to receive multicast MMS messages from individual group service providers, such as service provider 9 shown schematically in FIG. 1. The user of the set top box may register with group service provider 9 by sending details of the identification code for STB1 to the group service provider in a similar fashion to the registration procedure carried out at digi-tv centre 5. The group service provider 9 then provides a corresponding message address and an associated encryption/decryption key pair. Group message addresses are shown in Table 2 for two individual group service providers, namely a horse club and an amateur radio society.

Table 2

| | | Encryption/ |
|---|---|---|
| STB 1 Identification | | decryption |
| code | Group message addresses | key pair |
| wbdcxz485407437347 | horseclub@turkutv.fi | Kf1:Kf2 |
| | radioamateurs@turkutv.fi | Kg1:Kg2 |

The addresses and associated encryption/decryption keys can be sent to STB1 in a similar manner to that shown in FIG. 3 and encrypted MMSs may be multicast to subscribers of the multicast service from the or each group service provider 9. The key pair communication, encryption of messages and initial settings can be carried out from a number of different physical locations depending on the mutual agreements between the operators of the digi-tv centre 5 and the group service provider 9. If public/private key cryptography is used, the message encryption can happen at many places along the MMS message transmission path. It will be understood that messages from group service provider 9 may be multicast to more than one set top box e.g. STB1 and STB2 shown in FIG. 1 which have subscribed to the group service. Also, a billing system (not shown) is provided to allow the operator of service provider 9 to charge for the downloaded MMS messages accessed by users of the STBs.

Many modifications and variations of the disclosed system fall within the scope of the claimed invention. For example, the MMS may include an audio clip or video clip which may be displayed by the television receiver 7. Also, STB 1 may be integrated onto the television receiver 7. Furthermore, the invention is not restricted to use with DVB-T and can be used with other digital broadcast systems including satellite and cable. Also the invention may be used with messages other than MMS messages that are derived from or emanate from networks other than the digital broadcast network. Many other additional embodiments will be envisaged by the skilled person.

1. A method of configuring a digital broadcast receiver to receive individually addressed messages through a digital broadcast network, the messages being derived from a different network, comprising sending to the digital broadcast receiver through the network message detection data that allows the digital broadcast receiver to identify messages broadcast through the network with at least one individual address corresponding to the digital broadcast receiver, and storing the message detection data for use in the digital broadcast receiver to detect messages addressed thereto.

2. A method according to claim 1 wherein the messages comprise MMS messages.

3. A method according to claim 1 wherein the digital broadcast receiver comprises a set top box.

4. A method according to claim 1, wherein each digital broadcast receiver has substantially unique key stored therein, and the message detection data is encrypted using said key, and the method, includes decrypting the message detection data with the key at the digital broadcast receiver and selectively storing the decrypted data in the digital broadcast receiver.

5. A method according to claim 1, wherein each digital broadcast receiver has an individual identification code, and the message detection data includes identity data corresponding to the identity of the digital broadcast receiver that is already stored in the receiver, and the method includes identifying said identity data corresponding to the stored data in the digital broadcast receiver and selectively storing in the digital broadcast receiver the sent detection data corresponding to the stored identity data.

6. A method according to claim 1, wherein the detection data includes at least one address for messages corresponding to the identity data for the digital broadcast receiver.

7. A method according to claim 1, wherein the detection data includes a decryption key corresponding to the address for decoding encrypted messages sent to the address at the digital broadcast receiver.

8. A method according to claim 1, wherein said address comprises a group address for a message multicast through the network.

9. A method according to claim 1, wherein the detection data includes a plurality of addresses associated with said identity and decryption keys associated with the addresses individually.

10. A digital broadcast receiver configured by a method as claimed in claim 1 to receive MMS messages.

11. A method of sending MMS messages to a set top box configured as claimed in claim 10, comprising transmitting the MMS through the digital broadcasting network and detecting the MMS at the set top box using said detection data.

12. A method of operating a digital broadcast network to configure a digital broadcast receiver to receive individually addressed messages through the network, the messages being derived from a network different from the broadcast network, comprising receiving specific data that individually characterises a particular digital broadcast receiver, providing message detection data as a function of said specific data that allows the digital broadcast receiver to identify messages broadcast through the network with at least one individual address corresponding to the digital broadcast receiver for storage therein to detect messages addressed individually thereto, and sending the Message detection data to the digital broadcast receiver through the network.

13. A method according to claim 12, wherein specific data corresponds to a substantially unique key associated with the, and the method includes encrypting the message detection data with the key.

14. A method according to claim 12, wherein specific data corresponds to an individual identification code for the digital broadcast receiver and the method includes including the individual identification code in the message detection data.

15. A method according to claim 12, wherein the specific data comprises information that corresponds to at least one address for MMS messages for association with the digital broadcast receiver, and the method includes providing said at least one address in the message detection data.

16. A method according to claim 15, wherein the specific data includes a decryption key corresponding to the address and the method includes providing said decryption key in the message detection data.

17. A method according to claim 1, wherein the specific data includes a plurality of addresses associated with said identity and decryption keys associated with the addresses individually, and the method includes providing said addresses and said keys in the message detection data.

18. A network adapted to perform a method as claimed in claims 12.

19. A network according to claim 18, adapted to send MMS messages to a set top box.

20. A method of configuring a digital broadcast receiver to receive individually addressed messages through a digital broadcast network, the messages emanating from a network different from the digital broadcast network, comprising receiving at the digital broadcast receiver from the digital broadcast network, message detection data that allows the digital broadcast receiver to identify said messages broadcast through the network with at least one individual address corresponding to the digital broadcast receiver, and storing the message detection data for use in the digital broadcast receiver to detect messages addressed thereto.

21. A method according to claim 20, wherein the digital broadcast receiver comprises a set top box and the method configures the set top box to receive MMS messages.

22. A method according to claim 12, wherein the specific data includes a plurality of addresses associated with said identity and decryption keys associated with the addresses individually, and the method includes providing said addresses and said keys in the message detection data.
